(19) United States
(12) Patent Application Publication
(10) Pub. No.: US 2018/0240151 A1
(43) Pub. Date: Aug. 23, 2018

(54) ELECTRONIC ROUTING AND MESSAGING IN A VENUE BASED ON WAIT TIMES

(71) Applicant: PANASONIC INTELLECTUAL PROPERTY MANAGEMENT CO., LTD., Osaka (JP)

(72) Inventors: Michael Glynn D'ANDREA, Burlington, VT (US); John CRONIN, Bonita Springs, FL (US); Kota MORISAKI, Arlington, VA (US)

(73) Assignee: PANASONIC INTELLECTUAL PROPERTY MANAGEMENT CO., LTD., Osaka (JP)

(21) Appl. No.: 15/437,993

(22) Filed: Feb. 21, 2017

(51) Int. Cl. G06Q 30/02; G01C 21/36; G01C 21/34

(52) U.S. Cl. CPC G06Q 30/0252; G06Q 30/0255; G01C 21/3617; G01C 21/3484; G01C 21/3691; G01C 21/3415; G01C 21/3697

(57) ABSTRACT

Messaging based on a wait time for an attraction is provided. Visitor attraction interest information, attraction condition information, and attraction traffic information is acquired using a processor. A first visitor route is calculated based on the visitor attraction interest information. A first attraction wait time is calculated based on the first visitor route, the attraction condition information and the attraction traffic information. A second visitor route is calculated if the first attraction wait time that is calculated exceeds a pre-determined threshold. Then, a second attraction wait time is calculated based on the acquired visitor attraction interest information and the at least one second visitor route. The processor determines an alternative attraction based on the at least one second attraction wait time and identifies an incentive corresponding to the alternative attraction. The incentive is displayed on a user interface.

### BACKGROUND

### 1. Field of the Disclosure

The present disclosure relates to the field of resorts, theme parks, amusement attractions and other venues having attractions. More particularly, the present disclosure relates to electronic routing and messaging in a venue based on wait times.

### 2. Background Information

Resorts, theme parks, and amusement attractions provide a visitor with enjoyment as the visitor navigates about the venue, attends attractions in the venue, interacts with various games and contests, attends live entertainment, and enjoys food and drink. Excessive wait times detract from the experience.

### BRIEF DESCRIPTION OF THE DRAWINGS

FIG. 1 shows an exemplary general computer system that includes a set of instructions for electronic routing and messaging in a venue based on wait times, according to an aspect of the present disclosure;

FIG. 2 shows an exemplary venue with attractions that may be frequented by visitors for electronic routing and messaging in a venue based on wait times, according to an aspect of the present disclosure;

FIG. 3 shows an exemplary architecture schematic of a system for electronic routing and messaging in a venue based on wait times, according to an aspect of the present disclosure;

FIG. 4 shows an exemplary flow diagram of a system for electronic routing and messaging in a venue based on wait times, according to an aspect of the present disclosure;

FIG. 5A shows an exemplary display of an incentive offer source page for electronic routing and messaging in a venue based on wait times, according to an aspect of the present disclosure;

FIG. 5B shows an exemplary second page displayed upon the selection of an electronic link on the source page associated with the incentive for electronic routing and messaging in a venue based on wait times, according to an aspect of the present disclosure;

FIG. 5C shows another exemplary second page displayed upon the selection of an electronic link on a source page associated with a plurality of incentives for electronic routing and messaging in a venue based on wait times, according to an aspect of the present disclosure;

FIG. 6 shows an exemplary flow diagram of visitor wait time calculation for electronic routing and messaging in a venue based on wait times, according to an aspect of the present disclosure;

FIG. 7 shows an exemplary diagram of visitors waiting in line for an attraction for electronic routing and messaging in a venue based on wait times, according to an aspect of the present disclosure;

FIG. 8 shows exemplary circuit components of a wearable monitor for electronic routing and messaging in a venue based on wait times, according to an embodiment of the present disclosure;

FIG. 9 shows an exemplary diagram of beacons in the venue for electronic routing and messaging in a venue based on wait times, according to an aspect of the present disclosure; and

FIG. 10 shows an exemplary visitor record with visitor preferences for electronic routing and messaging in a venue based on wait times, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

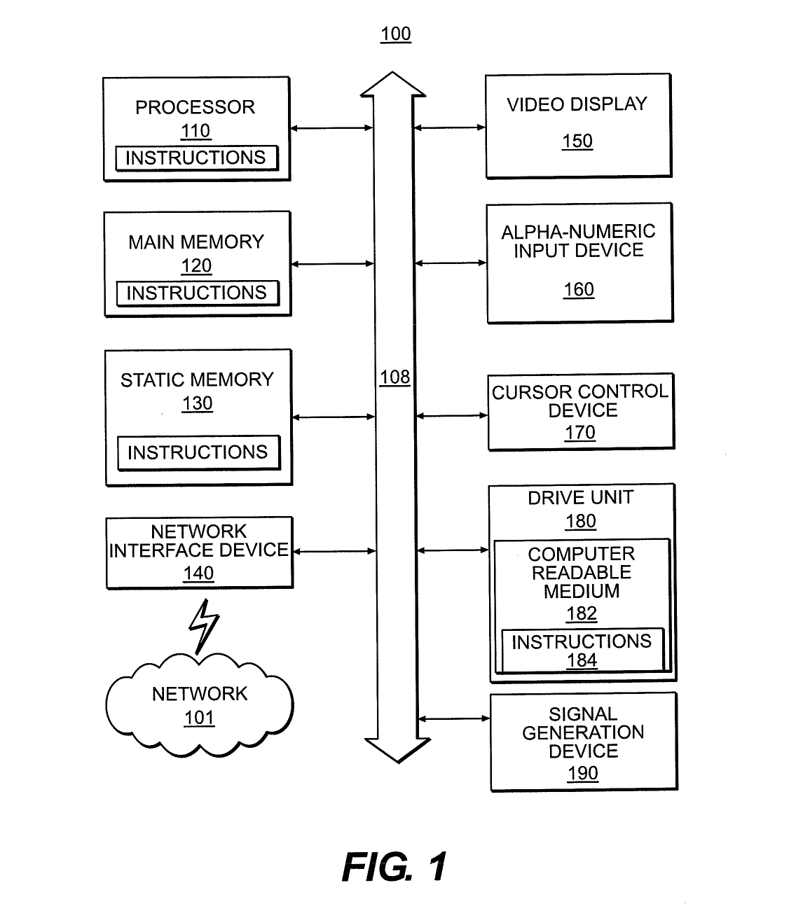

FIG. 1 is an illustrative embodiment of a general computer system, on which a method of electronic routing and messaging in a venue based on wait times can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a global positioning satellite (GPS) device, a communications device, a control system, a camera, a web appliance, a network router, switch or bridge, virtual reality system, augmented reality system, a sensor, and monitor, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen, pad, augmented reality input device, visual input device, video input device, 3D input device, human eye position input device, haptic input device, body tracking device, acoustic tracking device, or a data glove. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

The present disclosure employs a distributed architecture to continuously monitor wait times at attractions as well as a visitor's current location. When a wait time at a visitor's intended attraction exceed a pre-determined threshold, the combination of hardware and software components interact to calculate an attraction closest to the present location of the visitor's location and/or route that most closely matches the interests of the visitor. Furthermore, the combination of hardware components may identify an incentive, based upon a stored profile of the visitor, that would be most likely to succeed in motivating the visitor to alter their intended route. In doing so, ride condition, wait times, and visitor location are constantly monitored to determine accurate wait times. Thus, an on the fly minimization of visitor wait times may be achieved.

Furthermore, the distributed architecture enables load distribution, reducing congestion and bottlenecks, while still allowing the data to be accessible from a central location.

As a result, venue operators and managers can route visitors away from attractions that the visitors have expressed an interest in visiting when the current estimated wait time is too great, and route the visitors to alternate attractions that match the interests of the visitors but have shorter wait times. Therefore, the overall satisfaction with the experience is increased.

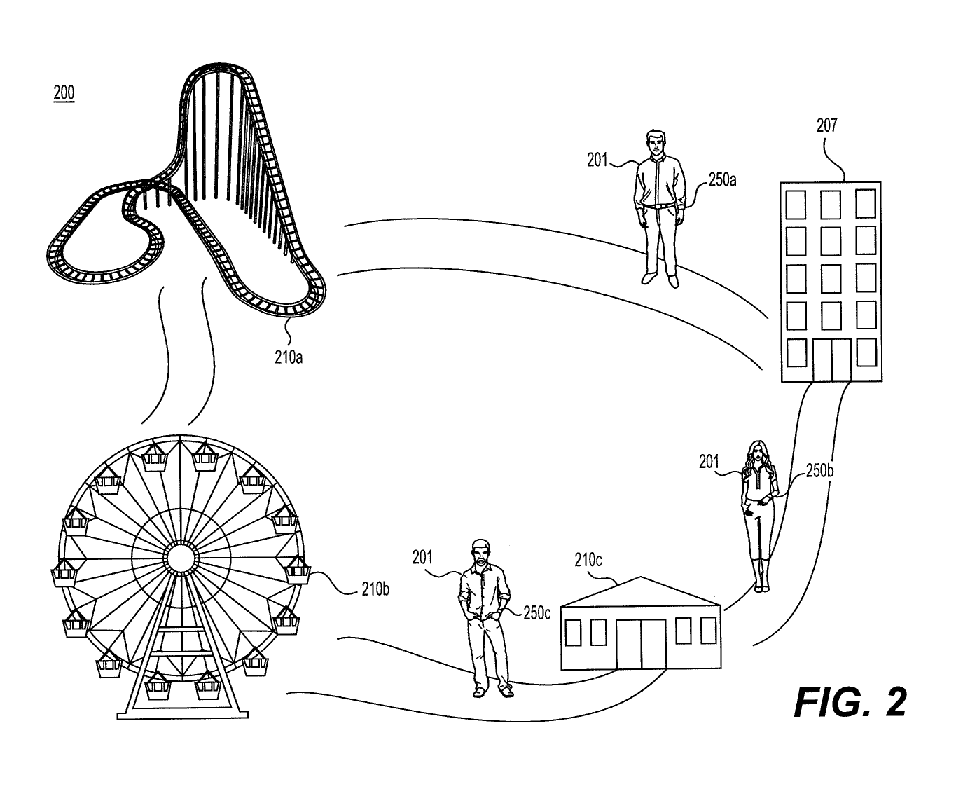

FIG. 2 is an illustrative embodiment of a venue 200, in which a method of electronic routing and messaging in a venue based on wait times may be implemented. The method, and various embodiments thereof, may be implemented locally within a predetermined device. On the other hand, some or all of the steps of the method may be implemented on an external network. Exemplary venue 200 includes one or more attractions 210a-c which may be visited by one or more visitors 201. Furthermore, the one or more visitors 201 may wait in lines in order to gain entry to the attractions 201.

In the illustrative embodiment of FIG. 2, the venue 200 includes a plurality of attractions 201 with corresponding wait lines. Here, for example, a wait line corresponding to the attraction 210a has less people waiting than a wait line corresponding to the attraction 210b.

Also shown in FIG. 2 is hotel 207 that includes one or more rooms of various dimensions and shapes to satisfy the preferences of visitors 201. Hotel 207 may be located inside the venue 200 or outside of the venue 200. Venue 200 may refer to any one or more of a resort, hotel, travel destination, theme park, amusement park, hiking park, casino, golf course, museum, campus, or travel destination, for example. In a non-limiting example, the venue 200 may refer to a resort. In an alternative non-limiting example, the venue 200 may refer to a hotel and an amusement park. Specifically, the venue 200 encompasses any facility, location, or place, providing physical boundaries to fulfill one or more objectives of the present disclosure.

Visitors 201 may physically occupy a premise on venue 200 for a duration of time. In addition, visitors 201 may directly compensate the operator, or an entity related to the operator, for its services provided to visitors 201. Alternatively, the visitors 201 may not be expected to compensate for services provided them, such as where another entity pays on behalf of the visitor 201 or the visitor 201 does not incur expenses by visiting the venue 200.

The term operator, as used herein, may refer to any entity acting on behalf of the venue 200 who may affect the satisfaction of its visitors 201. For example, an operator may be a travel management company, or alternatively, an operator may be a government entity. A non-exhaustive and exemplary list of operators may include both nonprofit and for-profit entities. In addition to travel management companies, for-profit operators may include entities engaged in earning profits at amusement parks, casinos, museums, resorts, hotels, or other venues. Also, in addition to government entities, nonprofit operators may include educational universities or arts organizations, for example.

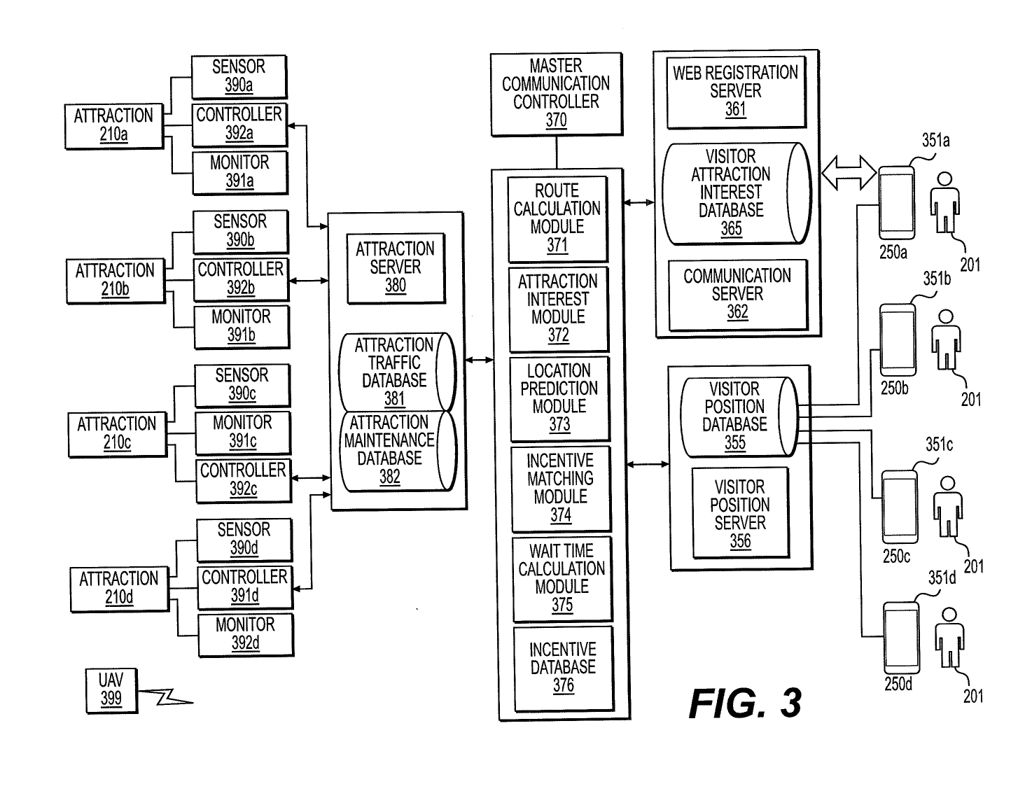

A venue 200 includes one or more attractions 210a-c. Each attraction includes at least one visitor 201 waiting in line to experience one or more of the attractions 210a-c. Each of the visitors 201 has an electronic ticket which allows the visitor 201 to access the attractions 210a-c in the venue 200, as well as to the attractions within the venue 200. In one embodiment, the electronic ticket is displayable on a mobile device 250 of the visitors (as shown in FIG. 3). For example, the electronic ticket may be displayable on a graphical user interface (GUI) of a smartphone or on a GUI of a wearable band such as a wrist band. The GUI of the mobile device 250 also permits the visitor to receive incentives, coupons, and offers from the venue operators or other entities within the venue such as vendors. The venue 200 may also include a hotel 207. It is clear that while a number of visitors 201 and attractions 210a-c are shown, the actual number of each is virtually limitless.

FIG. 3 shows an exemplary architecture schematic of the system for electronic routing and messaging in a venue based on wait times, according to an aspect of the present disclosure. It is clear that any type of wireless mobile devices are contemplated for mobile devices 250a-c, including wearable wireless devices, computers, tablets, fitness bands and trackers, cameras, smart glasses, and Bluetooth™ devices, smartphones, and the like.

A mobile application 351a-d is accessible with or installed upon each of the mobile devices 250a-d. The mobile devices 250a-d of the visitors 201 are used to track the respective visitor as the visitor traverses the venue 200 and attends the attractions 210a-c. For example, global positioning satellite (GPS) coordinates associated with the location of the mobile devices 250a-d are obtained. The geographic coordinates are determined by communications between the mobile devices 250a-d and one or more satellites (not shown). The determined geographic coordinates are then transmitted from the mobile devices 250a-d, or from sensors around the venue 201, that receive GPS signals from the mobile devices 250a-d, to a visitor position database 355.

In this regard, the applications 351a-d may be downloaded or accessed at the time the visitors 201 enter the venue 200, while the visitors are already in the venue 200, or prior to the visitors' arrival at the venue 200. In an embodiment, information on the applications 351a-d on the mobile devices 250a-d of the visitors 201 serves as the electronic ticket for the venue 200, providing access to the venue 200 and the attractions 210a-d.

In one embodiment, when the visitors 201 download the mobile applications 351a-d, the mobile applications 351a-d present the visitor 201 with a survey page via the GUI on the mobile devices 250a-d. The survey solicits attraction interests of the visitors 201 that will be used to calculate one or more routes for the visitors 201 through the venue 200 or will be used for selecting one of incentives that are offered to the visitors 201 in predetermined criteria described hereinafter.

For example, the survey solicits from the visitor 201 what attractions that the visitor 201 would like to visit. In one embodiment, the survey permits the visitor 201 to rank the attractions according to an order of preference. The survey may allow the visitor 201 to input a list of attractions or present a list of attractions from which the visitor may select, for example, by checking a box or clicking indicia on the display. Based upon the visitor 201 input, an itinerary may be automatically generated for the visitor 201, including a map displaying a route to all of the attractions 210a-c identified by the visitor 201 to be of interest.

As another example, in an amusement park scenario, the visitors 201 may be asked if they prefer water rides or scary roller coasters. In a casino, the visitors 201 may be asked if they prefer blackjack, craps, or roulette. With regard to food and drink, the visitors 201 may be asked what type of food they prefer. The survey questions may be opened ended, allowing the visitor 201 freedom to enter words of their choice. Alternatively, survey questions may be close ended in which choices may be provided from which the visitor may make one or more selections. A combination of open ended and close ended survey questions may also be provided. By soliciting such interests of the visitors 201 via the mobile application 351a-d of the mobile device 250a-c in advance, the claimed features are able to provide a faster system, leading to enhanced visitor enjoyment.

A web registration server 361 provides a web and Internet interface and presents the visitors 201 with the survey and subsequently receives the survey responses. The survey responses are then transmitted from the registration server 361 to a visitor attraction interest database 365 for storage. A communication server 362 handles communications with other elements in the system.

The visitors 201 are registered, for example, with the web registration server 361, so that the visitor 201 may be presented with a route through the venue 200 that will include the preferred attractions indicated by the visitor 201 in the survey. Additionally, survey answers provided by the visitor 201 allow the venue 200 to offer incentives to the visitor 201 that are determined to be appealing to the visitor. That is, the offered incentives to the visitors 201 may be selected from a plurality of options based on the survey answers. For example, if the visitor 201 indicated in the survey that they like pizza, an incentive offered to the visitor 201 may be associated with pizza.

As part of the registration process, the visitor 201 may be assigned an identification number which is stored in the registration server 361. In lieu of an arbitrary identification number, a smartphone telephone number, or communications address, or wearable device identifier may be used. By virtue of the registration process, the venue 200 is able to distinguish between visitors, given that each visitor is associated with a specific mobile device 250. Alternatively, the identification number may be assigned to the mobile device 250 by registration server 361 when the visitor 201 downloads mobile application 351 on the mobile device.

With regard to the identification of the position of the visitors 201, several techniques may be used, including GPS, RFID, Wi-Fi, NFC, Bluetooth, cellular, etc.

Additional or other techniques for determining the position of the visitors 201 may be employed. For example, the mobile devices 250a-d have imaging devices such as a camera and/or a scanner. In this regard, the visitor 201 may be prompted by the communication server 362 or requested at various locations in the venue 200 to scan or photograph indicia located at various points in the park, which would be uploaded to the visitor position server 356 for storage in the visitor position database 355 used to determine the position of the visitors 201. For example, the visitors 201 may be prompted to scan or photograph QR codes, bar codes, or other indicia adjacent to attractions in the venue 200. In one aspect, the communication server 362 or the visitor position server 356 sends a request to the visitors 201 via the mobile devices 250a-d to scan or photograph indicia located along a route of the venue 201. In another aspect, static or electronic signs near certain attractions 210a-c may request that the user scan or photograph nearby indicia. Using the mobile application 351a-d, the visitors 201 may upload any scanned image or photograph to a visitor position server 356, which stores the visitor position in the visitor position database 255.

In another aspect, rather than static or electronic signs near certain attractions 210a-c, the visitors 201 may transmit or receive signals or messages from an unmanned aerial vehicle (UAV) 399 such as a drone. Such signals between the visitors 201 and the UAV 399 may also be via Bluetooth™, Wi-Fi, cellular, or the like. The signals exchanged between the visitors 201 and the UAV may be used to identify the particular visitor and location thereof, for example, a MAC address of the mobile devices 250a-d, with the UAV 399 transmitting the identifying and location information back to the visitor position sever 356.

In an embodiment, the visitors 201 may earn bonus points for photographing or scanning the aforementioned indicia within the venue 200. The bonus points may then be applied toward purchases of food, drink, souvenirs, or a priority ticket that with which the visitor 201 can ride on the attraction preferentially without waiting in line for a long time in the venue 200 or get an exclusive item or service that other guests cannot get unless having the bonus points. Such bonus points would encourage compliance with any photographing or scanning desired by the venue 200. Alternatively, if the visitor 201 earns the bonus points and the earned bonus points are greater than predetermined points, incentives offered to the visitor may be of a higher quality or be more expensive, such as premium incentives.

A master communication controller 370 is a processor that controls communications between modules, databases, and other servers in the venue 200. It is noted that the communication between the various elements in the system may be wired, wireless, or any combination thereof. The master communication controller 370 may be a centralized processor or server.

For example, the master communication controller 370 may monitor the visitor position database 355 and control modules 371, 372, 373, 374, 375, and incentive database 376. The master communication controller 370 may also monitor an attraction traffic database 381 and an attraction maintenance database 382, and communicate with an attraction server 380, the visitor position server 356, and the communication server 362.

The route calculation module 371 stores an updatable map of the venue 200 and calculates one or more routes or paths through the venue 200 for each visitor 201. For example, the route calculation module 371 calculates a first visitor route based on the visitor attraction information stored in the visitor attraction interest database 365. The visitor attraction information stored in the visitor attraction interest database 365 may be pushed or pulled from the visitor attraction interest database 365, by the master communication controller 370 or the communication server 362.

The attraction interest module 372 receives the visitor attraction interest information stored in the visitor attraction interest database 365 includes rankings for each visitor according to survey information provided by each of the visitors 201.

The visitor location prediction module 373 predicts the movement and behavior of the visitors 201 as they traverse the venue 200. The visitor location prediction module 373 may include a database used to predict in real time the future behavior of a guest for which a partial trajectory is available. Such a partial trajectory might be computed from various location-sensing technologies, such as GPS on a smartphone, worn RFID tags read by fixed sensors, facial recognition via cameras, or even point-of-sale payment records. Typically, such a trajectory might be incomplete, since all known location-sensing technologies produce incomplete data due to missed or erroneous readings. To address this issue, a closest match in the set of exemplar trajectories for the partial trajectory may be employed. The closest match can then be used as the basis for predicting the locations that the visitor 201 will soon visit. This approach uses approximate or fuzzy string matching, in which a query string, in this case the partial trajectory, is matched against substrings in a dictionary of strings, in this case the exemplar trajectories in a database. The subject matter in U.S. Patent Application Publication No. 2014/0278688 is incorporated by reference in its entirety.

The incentive matching module 374 determines an incentive to offer the visitors 201, which is used to motivate the visitors 201 to visit an identified attraction, as will be discussed later. The incentive matching module 374 receives information that was obtained and stored in the visitor attraction interest database 365 to identify potential incentives that may be of interest to the visitor. For example, if the visitor 201 had indicated in the aforementioned survey that the visitor 201 likes t-shirts, the incentive matching module 374 may determine to offer an e-coupon to the visitor 201 for a t-shirt. The e-coupon incentive may be for a vendor or establishment within the venue 200, or for a merchant not affiliated with the venue 200.

The wait time calculation module 375 determines wait times for attractions of interest to the visitor 201. In this regard, attraction traffic information stored in attraction traffic database 381 is used by the wait time calculation module 375, as well as the information from the visitor attraction interest database 365. The attraction traffic information stored in the attraction traffic database 381 may be pushed or pulled from the attraction traffic database 381, be the master communication server 370 or attraction sever 380.

The incentive database 376 stores incentives for identified interest attractions of a visitor 201. For example, the match between identified interest attractions of a visitor may be represented as a key-value pair in the incentive database 376. Alternately, the incentive database 376 may be a relational database.

The attraction server 380 controls the distribution of information from the attraction traffic database 381 and attraction maintenance database 382 to the master communication controller 370.

Each of the attractions 210a-d includes traffic sensors 390a-d and condition monitors 391a-d. The traffic sensors 390a-d record the number of visitors currently visiting a particular attraction 210a-d in the venue 200, for example, standing in line and/or participating in an attraction 210a-d. The traffic sensors 390a-d transmit current visitor counts to the attraction traffic database 381 at predetermined intervals. In addition, the traffic sensors 390a-d may be polled as information is needed. Each of the attractions 210a-d also includes a controller 392a-d that controls the traffic sensors 390a-d and the condition monitors 391a-d, including facilitating communications between the traffic sensors 390a-d and the condition monitors 390a-d with the attraction server 380. Of course, the traffic sensors 390a-d and the condition monitors 390a-d include the necessary hardware and software to perform sensing and monitoring operations, and communications with the attraction server 380.

The traffic sensors 390a-d may be configured to detect anonymous device IDs from the mobile devices 250a-d of the visitors. In this regard, the number of anonymous device IDs received from a particular coverage area corresponds to a number of persons in line. In another embodiment, the traffic sensor 390a-d utilizes an infrared sensor using break-beam technology. For example, the traffic sensor 390a-d may be an infrared beam counter in which a horizontal infrared beam is projected across an attraction entrance, and that records a count each time the beam is broken. Another similar sensor may also be positioned at or near the exit of the attraction, in which cases visitors 201 leaving the attraction may be subtracted from visitors 201 entering the attraction.

In this regard, a transmitter and a receiver may be mounted on either side of an attraction 210a-d entrance. In another embodiment, the traffic sensors 390a-d are video-based sensors to detect persons walking or occupying a viewing area. The video-based sensor is configured to determine a direction of travel, entry, exit, and retains objects in its zone of detection in order to avoid counting the same person multiple times. The video-based sensor may be mounted adjacent the attraction entrances and/or exits.

A video counter that counts persons using camera imaging by the number of persons recorded. In this regard, adaptive algorithms may be used to provide video counting. In another aspect, the use of artificial intelligence or pattern recognition may be used to enhance the accuracy of video counting.

In yet another embodiment, a 3D sensor may be used that creates a 3D view of the direction area, enabling greater depth perception and the ability to calculate persons walking in any direction. In this regard, the 3D sensor is able to monitor multiple persons entering and exiting at the same time and distinguish between persons and objects. The 3D sensor may be mounted adjacent the attraction entrance and/or attraction exit.

In another embodiment, the traffic sensors 390a-d are thermal imaging counters using one or more array sensors that detect heat sources. In this regard, the thermal imaging counter is a directional sensor, which can provide entrance and exit count data using a lens with thermal imaging technology, detecting human infrared radiation.

In another embodiment, the traffic sensors 390a-d are Wi-Fi receivers that may pick up unique Wi-Fi management frames emitted from mobile devices 250a-d within range, for example, from the MAC address or other broadcast identifiers used with the mobile devices 250a-d.

It is noted that any combination of the traffic sensors 390a-d may be used in the various attractions 210a-c, and that certain attractions 210a-c may be better suited for certain types of the aforementioned traffic sensors 390a-d. It is further noted that the traffic sensors 390a-d may be positioned at entrances, exits, along waiting line areas of the attractions 210-d. Any of the aforementioned sensors may be located overhead in order to avoid any undesirable tampering.

In an embodiment, traffic sensors 390a-d determine the number of persons in line by observing the length of the line. For example, indicia may be placed at pre-determined locations along the waiting line area, and if the line of persons extends as far as the indicia, the traffic sensors 390a-d determine that the indicia corresponds with a pre-determined number of persons (e.g., twelve linear feet corresponds to eight persons). For example, a beam based traffic sensor 390 can detect the presence or lack of objects (i.e., persons) extending upon a linear waiting line path, adjacent linear distance indicia. In an embodiment, the traffic sensors 390a-d may send data each time a length of the line changes. The wait time calculation module 375 calculates an approximate waiting time for a person who lines up at the end of the current line. The approximate waiting time calculated by the wait time calculation module may take into account the number of persons in line, plus the actual ride times. For example, if the number of persons currently waiting in line is 51 and the ride seats 25 at one time, then at least two rides will be completed before visitor number 51 is seated.

The traffic sensors 390a-d transmits the number of visitors waiting in line for an attraction to the attraction traffic database 381 where the data is stored. The attraction traffic database 381 receives from each traffic sensor 390a-d the number of visitors waiting in line for an attraction and stores the data. The attraction traffic database 381 makes this information available to the master communication controller 370 at predetermined intervals. However, continuous or periodic polling of the traffic sensors 390a-d and/or the monitors 391a-d by the master communication controller 380 or the attraction server 370 may also be performed to calculate wait times or visitor routes, as needed. In an embodiment, the attraction sensors 390a-d and/or the condition monitors 391a-d may transmit data to the attraction server 380 continuously or periodically without polling.

In addition to polling, a heartbeat signal may be sent from the attraction server 380 at predetermined intervals to ensure that the sensors 390a-d and/or the monitors 391a-d are operating properly. For example, a heartbeat signal may be sent from the attraction server 380 to the sensors 390a-d and/or the condition monitors 391a-d if data from the attraction sensors 390a-d and/or the monitors 391a-d has not been received in a predetermined period of time. As another example, a continuous heartbeat signal may be sent from the attraction server 380 to the sensors 390a-d and/or the monitors 391a-d such that any interruption in proper functioning of the sensors 390a-d and/or the monitors 391a-d is detected immediately.

In an embodiment, a polling protocol may utilize a MAC protocol in which the sensors 390a-d and/or the monitors 391a-d send data to the attraction server 380 all the time. The attraction sever 380 may periodically transmit polling packets that contain IDs for the sensors 390a-d and/or the monitors 391a-d, by which the sensors 390a-d and/or the monitors 391a-d take turns transmitting data to the attraction server 380. The turns may be determined according to location of the sensors 390a-d and/or the monitors 391a-d, load of the sensors 390a-d and/or the monitors 391a-d in which the sensors 390a-d and/or the monitors 391a-d at busier attractions 210a-d may be able to transmit prior to the sensors 390a-d and/or the monitors 391a-d at slower attractions 210a-d, etc. In this embodiment, the sensors 390a-d and/or the monitors 391a-d may reside in a sleep mode when there is no data to transmit and wake up when there is data to transmit. In this regard, the sensors 390a-d and/or the monitors 391a-d may wait by monitoring the polling packet for its ID. Advantageously, this solution avoids collisions as only one of the sensors 390a-d and/or the monitors 391a-d can transmit to the attraction server 380 at one time.

The attraction condition monitors 390a-d detect conditions of the attractions. For example, if an attraction 210a-c is closed or out of service, the attraction condition monitors 290a-d detect such a condition and send such condition to the attraction maintenance database 382. The attraction monitors 391a-d may also include run times of the attractions 210a-d, number of visitors 201 that may participate in the attraction 210a-d at one time, and the like. For example, the attraction monitors 391a-d may track the length of a particular ride and the number of persons a ride can accommodate at one time. That is, the number of persons that can be accommodated in a ride at one time may vary, for example, based upon the number of cars being used on a roller coaster at a given time, which may vary due to maintenance schedules, peak hours, and the like. The attraction monitors 391a-d may accept input by attraction operators and may include video cameras. A maintenance history and/or schedule of the attractions 210a-c may also be stored in the attraction maintenance database 382.

In one embodiment, the attraction monitors 391a-d are infrared photoelectric sensors that are used to identify a position of a ride for example. In this regard, a transmitter on the attraction monitors 391a-d projects an infrared beam of light. A receiver reports when it sees the beam of light, and if it does not seem the beam of light, it will transmit a signal. In another embodiment, an inductive proximity sensor may be used, which are configured to detect metal to detect a position of the cars on the ride.

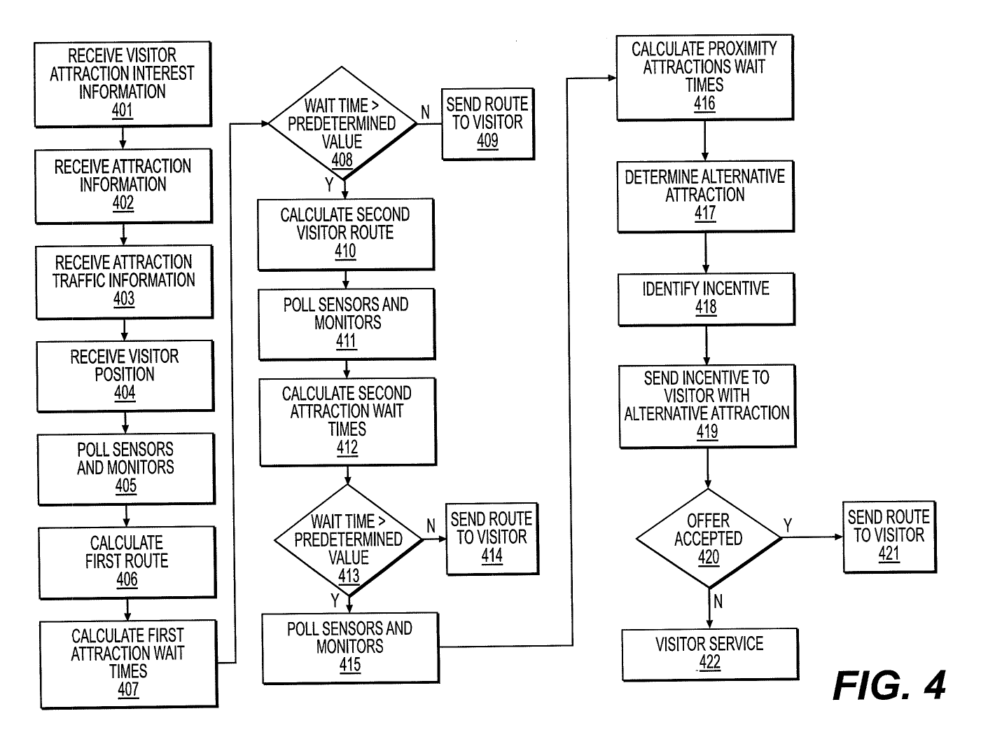

FIG. 4 shows an exemplary flow diagram of the system for electronic routing and messaging in a venue based on wait times, according to an aspect of the present disclosure. At step 401, visitor attraction interest information from the visitor attraction information database 365 is received. For example, the visitor 201 may complete a survey via an application on the mobile device 250 or a separate computing device. At this time, the visitor 201 can rank the attractions that they wish to attend, list interests, and food preferences, etc. Based upon the visitor attraction interest information, the route calculation module 371 calculates an itinerary including a route that would take the visitor 201 to all of the attractions indicated to be of interest to the visitor 201. In one embodiment, the route is sent to the mobile device 250 of the visitor 201. For example, route may be displayed on the GUI of the mobile device 250 so that the visitor 201 can see a map of the venue 200, a current location on the map, and the intended route through the venue 200.

At step 402, attraction condition information from the attraction information database 382 is received, such as whether each attraction is open or closed At step 403, attraction traffic information from the attraction traffic database 381 is received. For example, the information may include the number of persons in line at each attraction, or each attraction indicated by the particular visitor 201 to be of interest to the visitor 201.

For example, the visitor attraction interest information is obtained, for example, when the visitor initially downloads the mobile application 351a-d. In this regard, the mobile application 351a-d presents the visitor 201 with a survey page via the GUI on the mobile device, as discussed previously. In an alternative embodiment, another survey, which may be updated based on a variety of factors including venue conditions, may be presented to the visitor 201 as the visitor 201 traverses the venue. The attraction condition information is obtained through attraction monitors 391a-d. For example, if a particular attraction is undergoing maintenance, if the attraction operator is on break, then the attraction monitor 390a-d will send a message to the attraction maintenance database 382. The attraction information database 382 will subsequently send a message to the master controller 370 indicating with the information from the attraction monitors 391a-d. The attraction information in the attraction information database 382 may also include information about each attraction, such as height of a roller coaster, number of visitors the roller coaster can carry at one time, the minimum height required to ride the roller coaster, etc.

The attraction traffic information is obtained through attraction sensors 390a-d that are adjacent to or in the vicinity of each attraction. For example, the attraction sensors 390a-d detect the number of persons at an attraction (e.g., waiting in line for an attraction, viewing an attraction, interacting with an attraction). The attraction sensors 390a-d send a message to the attraction traffic database 381 for storage, thus additionally providing a historical indication of days and times of busy/idle times of each attraction 210a-d. The attraction traffic database 381 will subsequently send a message with information in the attraction traffic database 381 to the master controller 370.

At step 404, the visitor 201 location position information is received from the visitor position database 355 and/or is derived from the location prediction module 373. Based upon the current position of the visitor 201, a determination can be made as to whether the visitor 201 should stay on their current route or be redirected along a different route. For example, if the visitor 201 is headed to attraction X, and the wait time of attraction X is determined to be too long, then the system can redirect the visitor 201 to attraction Y, if attraction Y has a shorter waiting time. Another consideration for redirecting the visitor 201 to attraction Y can be the proximity of attraction Y to the current route or location of the visitor 201. In this regard, the attraction Y may be determined based on the visitor attraction interest information and a history of the attractions that the visitor has visited (e.g., ridden). For example, the attraction Y may be selected from attractions that the guest has not ridden during the present visit or during past visits.

Thus, the system advantageously provides automated scheduling updating, based upon various conditions within the venue 200, the position of the visitor 201, and the current route of the visitor 201. As a result, visitors 201 are not stuck with predetermined itineraries, faced with long wait times for attractions, or forced to self-navigate off of planned routes to other routes having other attractions which may suffer the same wait times.

In addition to wait times, another factor that may yield the automated scheduling updating is the maintenance status of the attractions 210a-c. That is, if a particular attraction 210 is determined to be closed or closing or maintenance, a visitor headed to attraction X may be automatically rerouted to attraction Y, if attraction Y is determined to be operational, has a wait time shorter than a predetermined limit, and/or is near to a current position of the visitor 201.

At step 405, the sensors 390a-c, monitors 390a-d are polled to receive the most up to date wait times and attraction condition information. The polling may be initiated, for example, by the master communication controller 370 or the attraction server 380. That is, attraction wait times and attraction condition information is constantly changing. Thus, and advantageously, obtaining the most up to date attraction wait times and attraction condition information is performed prior to calculation of wait times.

At step 406, a first visitor route is calculated based on the acquired attraction interest information, attraction information, and attraction traffic information. That is, the route calculation module 371 uses information obtained from the visitor attraction interest database 365, the attraction traffic database 381, and the attraction information database 382 to map a first visitor route about the venue 200. The first visitor route includes a route from the current position of the visitor, obtained from the visitor position database 355 and/or the location prediction module 373, to all of the attractions that were determined to be of interest to the visitor.

For example, if a particular visitor has been determined to be interested in the highest roller coasters, then a shortest path between the current location of the visitor and the highest roller coasters in the venue will be calculated. In one embodiment, the attraction information database includes a list of the tallest roller coasters in the venue, which are ranked according to height. Thus, in one embodiment, first visitor route includes a route in which all of the venues tall roller coasters will be on a path selected for the visitor. The visitor position database 355 continuously receives updates as to the position of each visitor 201 from the positioning hardware and software on the mobile devices 250a-d, via the visitor position server 356.

At step 407, expected wait times are calculated for attractions identified to be of interest to the visitor 201. The calculated wait times are calculated by the wait time calculation module 375 and are based on attraction traffic information from the attraction traffic database 381, attraction information from the attraction information database 382, and location information obtained from the location prediction module 373.

At step 407, a first attraction wait time is calculated based on the first visitor route that is calculated, the received ride condition information, and the received ride traffic information. That is, the wait time calculation module 375 uses the route determined at step 406 to calculate the wait times of the attractions based on the obtained attraction information and attraction traffic information. Additionally, the present position of the visitor 201 and/or information generated by the location prediction module 373 and or information from the visitor position database 355 may be used in determining which attractions for which to calculate wait times.

At step 408, if the wait time or wait times of the one or more first attractions does not exceed a predetermined value, then processing proceeds to step 409. At step 409, a route to the one or more attractions is transmitted to the mobile device 250a-d of the visitor 201. On the other hand, if the wait time or wait times of the one or more first attractions exceeds a predetermined value, processing proceeds to step 410.

At step 410, a second visitor route to one or more attractions, other than the attractions of the first route, is calculated if the first attraction wait time exceeds a predetermined threshold. If the first attraction wait time is determined to exceed a predetermined threshold (e.g., 60 minutes), then the route calculation module 371 determines one or more second routes for the visitor 201, based on the attractions deemed of interest to the visitor in the visitor attraction interest database. This step advantageously overcomes the problem of a visitor 201 who wants to attend a particular attraction, but the particular attraction waiting line is too long, which could lead to disappointment on the part of the visitor 201.

At step 411, the sensors 390a-d, monitors 390a-d are polled to receive the most up to date wait times and attraction condition information. That is, polling is performed to account for constantly changing values for the wait times and condition information.

At st412, a second attraction wait time for one or more attractions, other than the attractions of the first wait times, is calculated based on the acquired visitor attraction interest information and the calculated second visitor route.

At step 413, if a second attraction wait time is determined not to exceed a predetermined value, then the route to the second attraction is sent to the user for display on the mobile device 250a-d at step 414. At step 413, if the wait time of a second attraction of interest exceeds a predetermined threshold (e.g., 75 minutes), the sensors 390a-c, monitors 390a-d are polled at step 415 to receive the most up to date wait times and attraction condition information. Then the wait time calculation module 375 determines the wait times of attractions in proximity to the route between the visitor's current location and the visitor's destination at step 416. The visitor's destination may be determined using the location prediction module 373. Advantageously, this aspect limits a visitor's idle time, by finding wait times of attractions near to the visitor 201. In an alternative embodiment, steps 408 to 413 may be skipped.

At step 417, an alternative attraction is determined based on the calculated second attraction wait times. That is, the alternative attraction is determined based on the attraction most likely to be of interest to the visitor that is both on the visitor's current route, and that has a wait time less than a predetermined threshold (e.g., 30 min).

At step 418, an incentive corresponding to the determined alternative attraction is identified. That is, the incentive matching module 374 determines an appropriate incentive to entice the visitor to visit the alternative attraction. The incentive may include a free gift, a discount coupon that can be used for purchasing in the venue 200, points that can be used for obtaining services or gifts, a priority ticket for the attraction, a guaranteed reservation for a popular restaurant in the venue and a priority ticket for meeting a popular character or mascot in the venue.

At step 419, the incentive offered to the visitor may be based upon information that the visitor provided in response to the survey discussed above. For example, if the visitor responded to the survey that the visitor likes t-shirts, then a t-shirt coupon may be sent to the mobile device 250a-d of the visitor 201 through the mobile application 351a-d, which can be redeemed, for example, at a vendor in the venue 200.

In one embodiment, the incentive is offered to the visitor 201 via the mobile device 250 via an electronic link on a source page displayed on the mobile device 250a-d of the visitor 201 by, for example, the master communication controller 270 or the communication server 362. The electronic link on the source page is associated with an article of value or a service, the selection of the electronic link initiating an opportunity to acquire the article or service. By selecting the electronic link using a web browser, the master communication controller 270 or the communication server 362 receive from a web browser of the mobile device 250a-d a signal indicating activation of the electronic link and automatically identifies and retrieves stored data associated with the electronic link and generates and transmits to the web browser of the mobile device 250a-d a second page having an article corresponding to the source page. An electronic link generator may be employed to generate code that can add the electronic link to the source page.

As another example, a coupon for a free photograph taken while the visitor is on the alternative attraction may be sent to the mobile device of the visitor through the mobile application. Thus, a camera positioned adjacent a steep descent of the roller coaster could take a photograph of the user while the roller coaster is on the descent, which can be sent to the visitor, for example, shortly after the completion of the ride on the alternative attraction. Thus, the identified incentive is displayed on the mobile device of the visitor at step 419.

The incentive offered to the visitor at step 419 may include an “Accept” icon with which the visitor 201 can indicate whether they intend to accept the incentive. If the offer is accepted at step 420, the route to the alternative attraction is displayed to the visitor 201 at step 421. If the incentive is not accepted at step 420, a visitor service message may be transmitted to the mobile device 250a-d of the visitor at step 422.

For example, the incentive matching process may be performed by the incentive matching module 374. That is, visitor attraction interests for a particular visitor are received from the visitor attraction database 365. Then, the visitor attraction interests may be indexed to keys. A database lookup may be performed in the incentive database 376 to retrieve an incentive (value) linked with a particular key. Then, based on the key-value pair database object, an incentive is determined for the visitor based on the visitor attraction interests. The use of the key-value pairs result in enhanced searching and processing.

For example, each key-value pair may be a database object, in which the key of each pair may be any letter, number, symbol, string, and/or any other suitable representation of information usable to retrieve the a data structure from the database. The value of each pair may be a string, a number, a hash, a linked list, a data structure, and/or any other suitable representation of information.

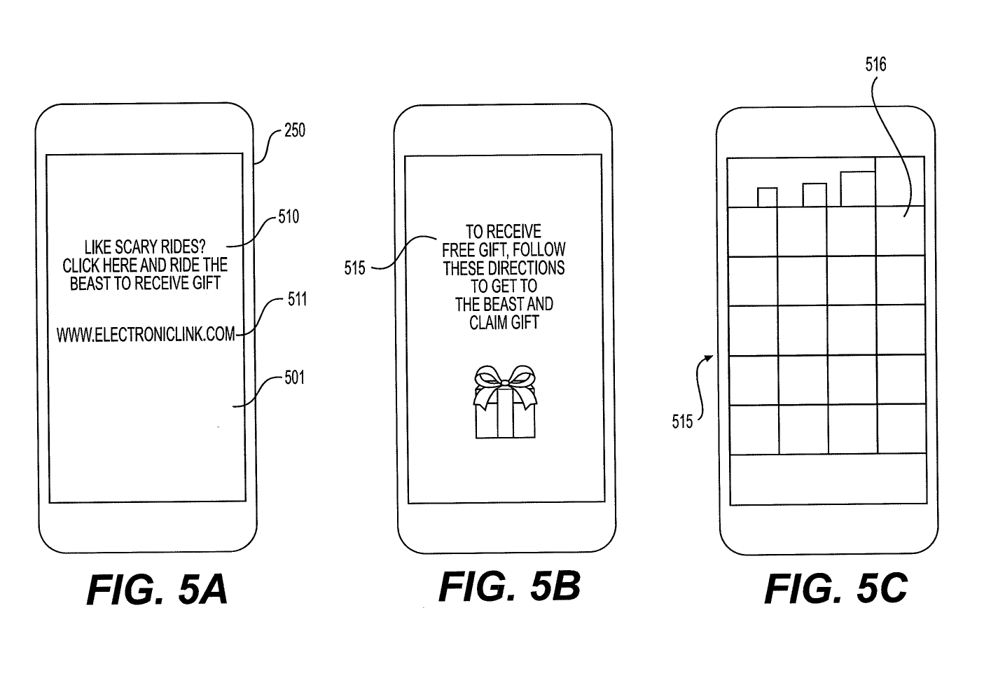

FIG. 5A shows an exemplary display of an incentive offer source page, according to an aspect of the present disclosure. As shown in FIG. 5A, the GUI of the mobile device 250 shows an incentive message offered to the visitor to visit an alternative attraction on a source page 501.

As indicated above, the incentive may be offered via an electronic link 511 on a source page 501 displayed on the mobile device 250 of the visitor 201 by, for example, the master communication controller 270 or the communication server 362. The electronic link on the source page 501 is associated with an article of value or a service (i.e., a gift), the selection of the electronic link initiating an opportunity to acquire the gift.

For example, if an alternative attraction with little to no wait time is determined at step 417, and the incentive matching module 374 determines that the visitor likes certain gifts, then the user may receive an incentive such as “Like Scary Rides? Click Here and Ride the Beast to Receive Free Gift” on the GUI of the mobile device 250. The source page 501 may or may not also indicate the specific nature of the gift, e.g., beer, t-shirt, discount on hotel room stay, etc.

FIG. 5B shows an exemplary second page displayed upon the selection of an electronic link on a source page associated with the incentive, according to an aspect of the present disclosure.

By selecting the electronic link using a web browser, the master communication controller 270 or the communication server 362 receive from a web browser of the mobile device 250a-d a signal indicating activation of the electronic link 511 and automatically identifies and retrieves stored data associated with the electronic link 511 and generates and transmits to the web browser of the mobile device 250a-d a second page 515 having an article corresponding to the source page 501.

In one embodiment, when the visitor is determined to be at the alternative attraction by information obtained from the visitor position database 355 or via the location prediction module 373, then an e-coupon may be sent to the mobile device 250. In another embodiment, a UAV, such as the UAV 399 may be dispatched by, for example, the communication server 362, the attraction server 380, or an operator of the venue 200, to the present or future location of the visitor 201 to for example, provide the visitor 201 with the gift.

FIG. 5C shows another exemplary second page displayed upon the selection of an electronic link on a source page associated with a plurality of incentives, according to an aspect of the present disclosure.

By selecting the electronic link using a web browser, the communication controller 270 or the communication server 362 receive from a web browser of the mobile device 250a-d a signal indicating activation of the electronic link 511 and automatically identifies and retrieves stored data associated with the electronic link 511 and generates and transmits to the web browser of the mobile device 250a-d a second page 515 having an article corresponding to the source page 501.

The second page 515 according to this aspect displays a plurality of panes, tiles, or selectable images of incentives 516, with each corresponding to a different incentive. In an embodiment, the potential incentives are displayed in a descending order of a likelihood of the visitor 201 to be interested in the potential incentives, based upon the survey responses provide by the visitor 201. In another embodiment, the potential incentives are displayed as tiles via a scaling technique such that the incentives determined to be more of interest the visitor 201 are progressively larger than adjacent tiles.

Then, when the visitor 201 reviews the displays, and selects one as the incentive that they would like to receive, the communication controller 270 or the communication server 362 receive from a web browser of the mobile device 250a-d, the selection of the visitor 201. In response a third page is transmitted to the web browser of the mobile device 250a-d, which displays the incentive to the visitor 201. In an embodiment, instructions as to how to receive the incentive are displayed to the visitor 201.

In one embodiment, the display of panes, tiles, or selectable images of incentives is achieved with an adaptive scaling technique providing a consistent size for each of the displayed elements, regardless of the size and resolution setting of the display of the mobile device 250a-d. For example, the incentive matching module 374 may determine or receive the dimensions or resolution of the display of the mobile device 250a-d and then determine a scaling factor by which to apply to ensure that the display of panes, tiles, or selectable images of incentives is rendered to provide a consistent size of the displayed elements, in accordance with the size and resolution setting of the display of the mobile device 250a-d.

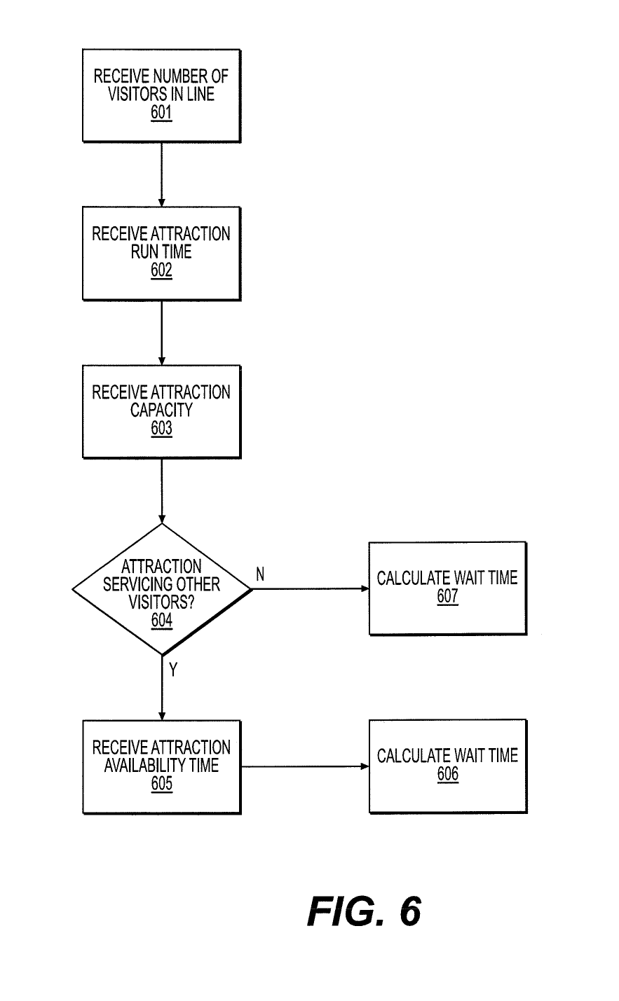

FIG. 6 shows a flow diagram for estimating wait time at an attraction at the venue, according to an aspect of the present disclosure.

At step 601, the wait time calculation module 375 receives the number of visitors at an attraction 210 from the attraction server 380, which is stored in the attraction information maintenance database 382. At step 602, the wait time calculation module 375 also receives the attraction run time of the attraction, which is stored in the attraction information database 382. At step 603, the wait time calculation module 375 receives the attraction run time number of visitors that can partake in the attraction at one time (i.e., the attraction capacity), which is stored in the attraction information database 382. At step 604, the wait time calculation module 375 receives an indication as to whether the attraction 210a-d is currently servicing other visitors from the attraction server 380, which is stored in the attraction information database 382. If the attraction is currently servicing other visitors (step 604=YES), the wait time calculation module 375 receives at step 605 an estimated time of when the attraction 210 will be available from the attraction information database 382. The wait time calculation module 375 then determines the estimated wait time at step 606. For example, if the attraction is a roller coaster, and if the attraction 210 run time is 5 minutes and attraction is currently one-half of the way through the ride, according to the monitor 391, then the wait time calculation module 375 determines that the attraction is available in approximately 2 minutes 30 seconds.

Then, if the attraction 210 can seat 100 visitors and there are 75 visitors in line, the wait time calculation module determines that the wait time is approximately 2 minutes 30 seconds. However, if there are more than 100 visitors in line, then the wait time calculation module 375 will determine that the wait time for the first 100 visitors in line is approximately 2 minutes 30 seconds. If there are more than 100 visitors in line, the wait time determines that the wait time is approximately 7 minutes 30 seconds for visitors 101-200 in line; approximately 12 minutes 30 seconds for visitors 201-300 in line, etc.

If step 604=NO, then the wait time calculation module 375 then determines the estimated wait time at step 607. For example, if the attraction is not serving other visitors 201, then the wait time may be less than one minute.

Since visitors may be joining or departing the line continuously, the master communication controller 370 or the attraction server 380 may poll the sensors 390a-d, 391a-d, and/or controllers 390a-d for information regarding the number of visitors in line and condition of the attraction 210a-d.

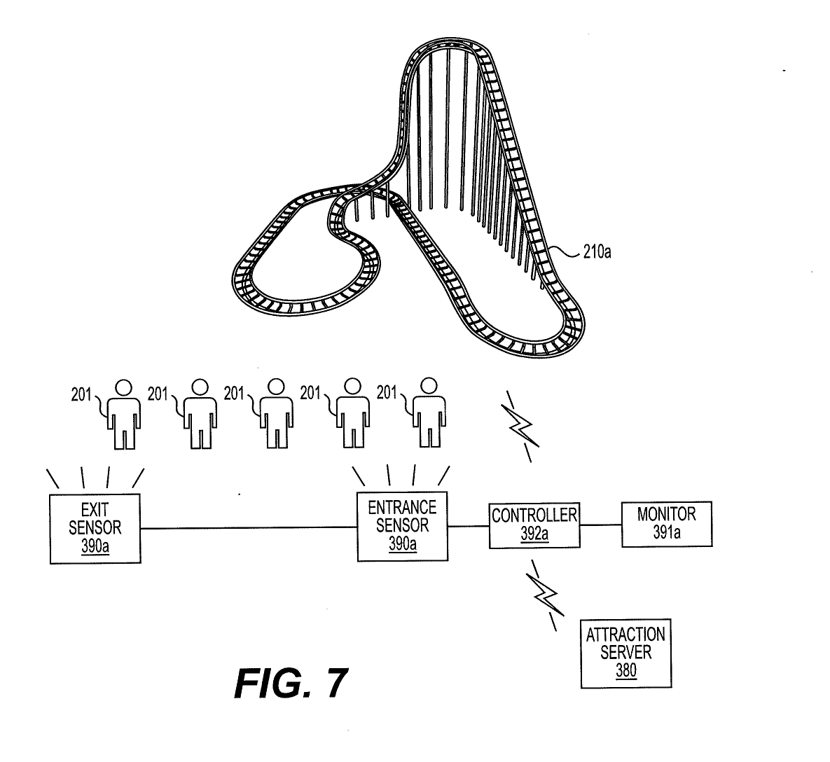

FIG. 7 shows an exemplary diagram of visitors waiting in line for an attraction, according to an aspect of the present disclosure. As shown in FIG. 7, a number of visitors 201 are waiting in line to ride on an attraction 210a. Sensors 390a positioned adjacent a waiting area for an attraction uses one of the aforementioned communication techniques for determining the number of visitors in line for the attraction 210a. In the present example shown, two sensors 390a, 390a to sense a presence of visitors 201 over a linear distance. The monitor 391a positioned in an adjacent area of the attraction 310 monitors a condition of the attraction 210. For example, the monitor 391 may detect whether the attraction is operation or down for maintenance. The monitor 391 may detect the operation information of the attraction 210 directly or by operator input into the monitor 391. The controller 392a facilitates transmission of the information in the sensor 390a and the monitor 391a to the attraction server 380.

In one embodiment, the monitors 391a-d include RFID tags with which maintenance history is recorded on the RFID tags and transmitted for storage in the attraction maintenance database 382.

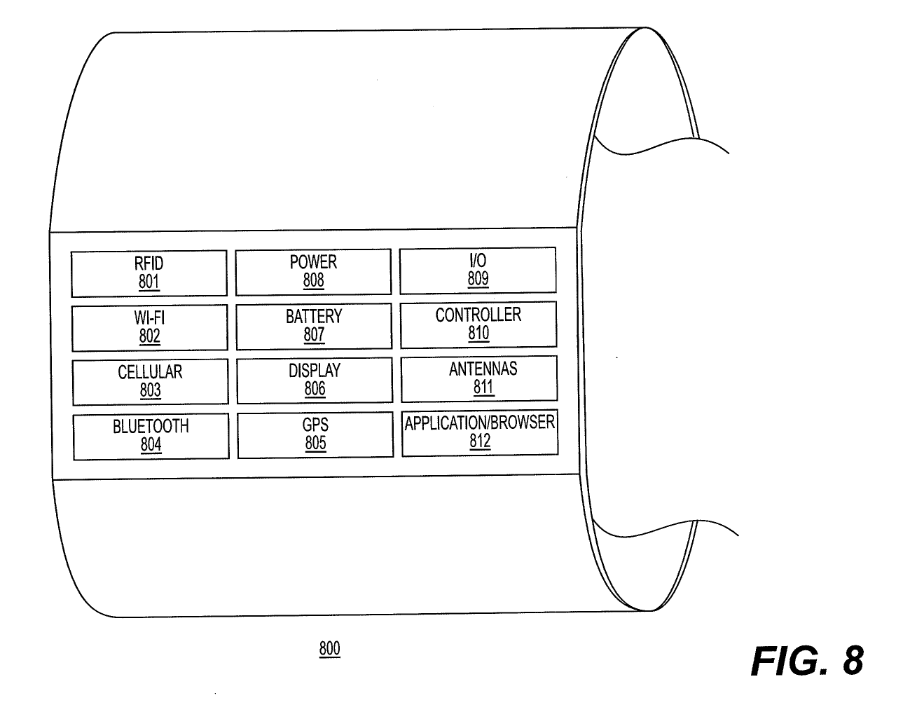

FIG. 8 shows exemplary circuit components of a wearable device, according to an embodiment of the present disclosure. According to the embodiment of FIG. 8, a wearable 800 is worn by the visitor 201. The band 800 may also serve as the electronic ticket of the visitor 201, given out by the venue 200 to the visitor 201.

The band 800 may include an RFID module 801, a Wi-Fi module 802, a cellular module 803, a Bluetooth™ module 804, a GPS module 805, a display 806, a battery 807, a power control 808, at least one I/O interface 809, a controller 810, one or more antennas to support RFID, Wi-Fi, cellular, and/or Bluetooth™ communications 811, and an application/browser 812.

The band 800 may be implemented using any appropriate hardware and software configured for wired and/or wireless communications over wireless networks and include the necessary chips to perform functions associated with each module, e.g., RFID chip. The browser application may be used, for example, to provide an interface to allow the visitor 201 to browse information over the Internet.

The RFID module 801 may include an RFID tag. The RFID tag 801 may be affixed or provided with the band 800 or to any other wearable or carried technology. The RFID tag 801 is configured to communicate and interact with tag sensors or beacons provided in strategic locations about the venue 200. For example, the tag sensors in the park are located at various strategic locations, including at rides, along routes, at restaurants, etc. The band 800 having the RFID tag 801 sends and receives RF signals through the antenna 811 in or on the band 800 that enables it to be detected by various short-range and long-range tag sensors or points within the venue 200.

When the RFID tag 801 is moved within the predetermined distance of one of the tag beacons (sensors), data from the RFID tag 801 is transmitted to the tag beacon. The data transmitted to the tag beacon includes information that allows the visitor 201 to be identified by identifying indicia such as an identification number of the band 800 and/or visitor 201. The information may also allow the visitor 201 to be identified by name or other demographic information. The RFID tag 801 may also include information that allows the visitor to be identified according to specific attractions and number of attractions visited during the visitor's present visit to the venue 200, and may include historical information as to the attractions that the visitor 201 has ever visited in the venue 200, etc.

Thus, location information of the visitor 201 may be obtained. The obtained location of the visitor 201 may be transmitted to the visitor position database 355.

The band 800 may also be provided with the Wi-Fi module 802 and/or a cellular module 803 and/or the Bluetooth™ module 804 to transmit information over a network. For example, Bluetooth module 804 may be configured to implement low energy Bluetooth (BLE) communication. For example, band 800 may detect various low energy Bluetooth signals from Bluetooth beacons installed at specific locations in the venue 200. Thus, the location and movements of the visitor 201 in the venue 200 may be detected by the various Bluetooth beacons. Of course, instead of RFID or Bluetooth beacons, cellular, Wi-Fi, NFC, may also be used, in any combination. That is, certain beacons may be more suited to certain locations within the venue.

The wearable band 800 may include a GPS receiver to receive location information of the visitor 201. For example, the GPS receiver may receive a GPS signal from satellites and thus provide the location of the visitor 201, which may be transmitted to the visitor position database 355.

The application 812 on the band 800 may allow the user to receive the survey questions from the web registration server 361. The survey may be displayed on the display 806 so that the user can respond to the survey questions with one or more of the I/O interfaces 809.

The wearable band 800 may also include at least one processor, such as a microprocessor controller, having at least one memory or storage. The tracker may also include circuitry by which a battery supplies power to the wearable band. The microprocessor is configured to process the obtained location information, which identifies the location of the visitor wearing the wearable band.

The GPS receiver circuitry may be used to receive and obtain the location of the wearable band. While the wearable band includes a GPS receiver, location information may also be obtained via alternative technologies, such as RFID proximity tagging, Bluetooth beacon technology, Wi-Fi triangulation, wide area network (or cellular) location assisted technology, or any combination of these technologies.

The visitors 201a-n may be detected by BLE beacons, GPS, NFC, or RFID, for example. For example, the system may detect when the visitor 201 joins a line and when the visitor 201 leaves a line. The beacons may also be located at various strategically placed locations about the venue 200 to detect visitors wearing the band 800.

The battery 807 is configured to supply power to the band 800 and is controlled by the power manager 808. The controller 810 controls the various modules and functionalities of the band 800.

In one embodiment, the band 800 may be a wearable bracelet, wristband, necklace, anklet, or other wearable or carryable item. Locations for the beacons include adjacent attractions 210a-n, in or around food courts, and stands, etc.

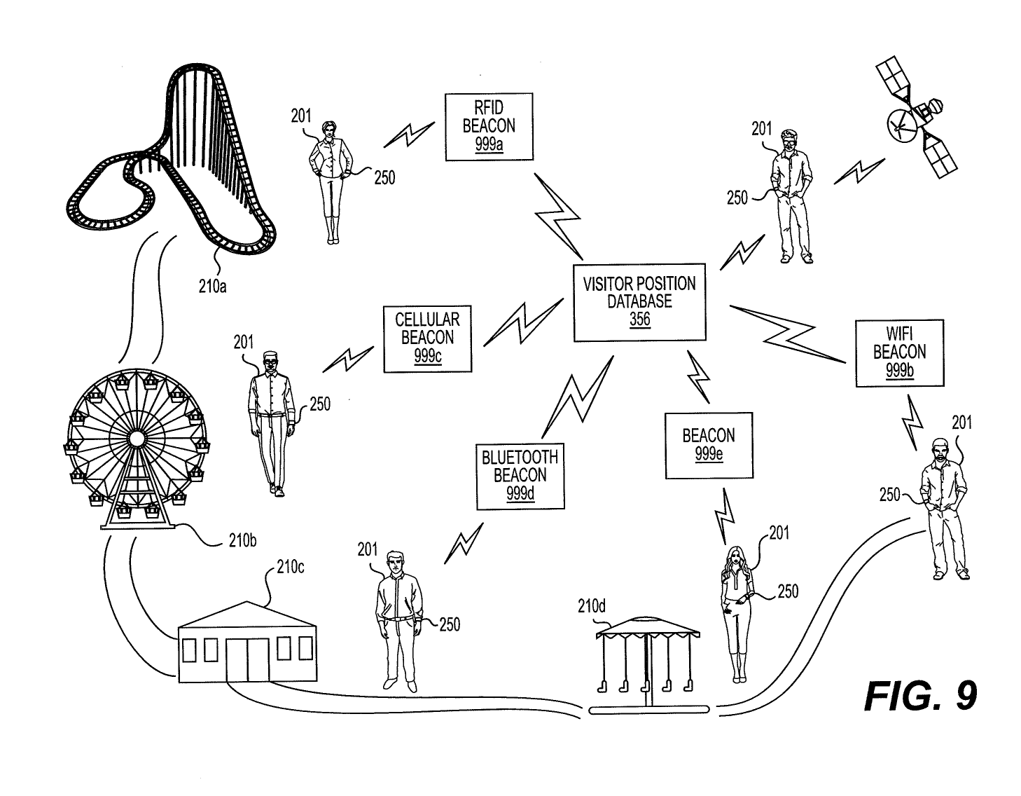

FIG. 9 shows an exemplary diagram of beacons in the venue, according to an aspect of the present disclosure.

Beacons 999a-e may be located in a plurality of sensing locations throughout the venue 200 and are configured to output signals to convey information related to the physical locations of the beacons 999a-e in the venue 200. The beacons 999a-e are configured to exchange signals with the band 800 to identify the position of the visitor 201 as the visitor traverses the venue 200.

As shown, the beacons 999a-e include an RFID beacon 999a, a Wi-Fi beacon 999b, a cellular beacon 999c, a Bluetooth beacon 999d. Signaling transmitted from the mobile devices 250a-c to the beacons 999a-e is sent to the visitor position/activity server 356 for storage in the visitor position database 355. For example, the location of each beacon 999a-e is known, so that when information from the mobile devices 250a-c is exchanged with the beacons 999a-e, including identification information associated with the particular mobile device 250 and particular visitor 201, the location of the visitor 201 can be established. GPS location information of the visitor 201 may be detected by a beacon 999e and sent to the visitor position database 356 via one of the aforementioned wireless communication methods or alternatively, the GPS location information may be sent directly from the mobile device 250 of the visitor 201 to the visitor position database 356.

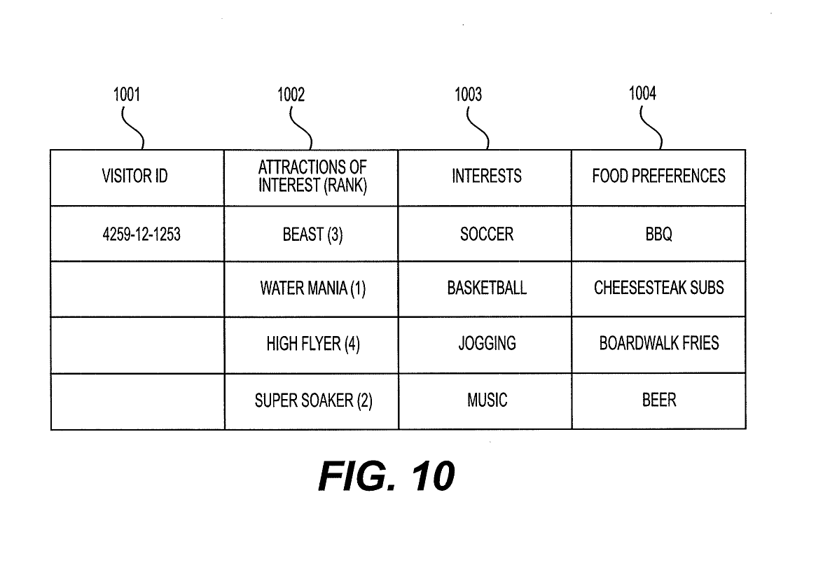

FIG. 10 shows an exemplary visitor record, according to an aspect of the present disclosure. That is the first column 1001 is an identification number of the mobile device 250 and/or the visitor 201. The second column 1002, taken from the survey completed by the visitor 201, is a listing of attractions ranked by the visitor 201 that the visitor wishes to attend during the visit to the venue 200, e.g., Beast, Water Mania, High Flyer, Super Soaker. As indicated in FIG. 10, the visitor has ranked their attractions from most desired to least desired as Water Mania (1); Super Soaker (2); Beast (3); and High Flyer (4), potentially indicating a preference for water attractions.

The third column 1003 is a list of interests of the visitor 201 as indicated by the visitor 201 on the survey, e.g., soccer, basketball, jogging, music. The fourth column 1004 is a list of the food preferences of the visitor as indicated by the visitor 201 on the survey, e.g, BBQ, Cheesesteak Subs, Boardwalk Fries, Beer.

As a result, the system advantageously enables venue operators to route priority visitors away from attractions that the visitors have previously indicated that they are interested in going to, when the estimate wait time is determined to be too long, which would result in lower satisfaction levels. Instead, the visitors would be routed to alternate attractions that still match the visitors' interests, but that such alternate attractions have shorter current wait times. Thus, the overall visitor satisfaction level is much more likely to be high, leading to positive reviews and repeat visits.

Thus, a routing system is provided for a venue that receives the visitors' preferred attractions and calculates a route for them to experience all of those attractions. The system then builds upon the experience by constantly monitoring wait times at attractions and the visitor's location. When wait times at a visitor's destination attraction exceed a pre-determined threshold, the system will calculate the attraction closest to the visitor's location/route that most closely matches their interests, and optionally identifies an incentive that, based on the visitor's profile, is most likely to succeed in motivating the visitor to change their route. The system constantly monitors ride condition, wait times and the position of all visitors in the park to keep wait time estimates as accurate as possible. The system also receives data from the ride traffic, visitor position and ride maintenance databases and uses the received data to calculate the visitor route based upon their current locations and wait times of attractions they are near to provide incentives to visit nearby rides.

Since the number of rides or attractions a guest experiences is a key operating metric for theme parks, the system a visitor device (e.g., an electronic ticket) to track the geolocation of the visitor in the venue, along with the attractions they have visited and the attractions they are going to. As the visitor walks by attractions on their route to their next destination, the electronic ticket or device notifies the visitor of nearby attractions which have shorter lines than their intended destination and optionally provides incentives to go to the rides with shorter wait times. This is a platform technology where the entrance ticket or device becomes automated to assist in helping visitors experience attractions.

Thus, resorts and venues are able to route their priority visitor (e.g., those who have subscribed to this system or who have a visitor mobile device) away from attractions they have previously stated they are interested in going to when the estimated wait time is too great (resulting in lower patron satisfaction levels) and route them to alternate attractions (that match the visitor's interests) with shorter wait times, thereby increasing their overall satisfaction with the experience.

Although electronic routing and messaging in a venue based on wait times has been described with reference to several exemplary embodiments, it is understood that the words that have been used are words of description and illustration, rather than words of limitation. Changes may be made within the purview of the appended claims, as presently stated and as amended, without departing from the scope and spirit of electronic routing and messaging in a venue based on wait times in its aspects. Although electronic routing and messaging in a venue based on wait times has been described with reference to particular means, materials and embodiments, electronic routing and messaging in a venue based on wait times is not intended to be limited to the particulars disclosed; rather electronic routing and messaging in a venue based on wait times extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards such as (Wi-Fi, Bluetooth, RFID, Cellular, GPS, NFC) represent examples of the state of the art. Such standards are periodically superseded by more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

According to an aspect of the present disclosure, a method is provided for messaging based on a wait time for an attraction. The method includes acquiring, using a processor, visitor attraction interest information, attraction condition information, and attraction traffic information. The method further includes calculating, with the processor, a first visitor route based on the visitor attraction interest information that is acquired. The method also includes calculating, with the processor, a first attraction wait time based on the first visitor route, the attraction condition information and the attraction traffic information. In addition, the method includes calculating, with the processor, a second visitor route if the first attraction wait time that is calculated exceeds a pre-determined threshold. Additionally, the method includes calculating, with the processor, a second attraction wait time based on the acquired visitor attraction interest information and the at least one second visitor route. The method also includes determining, with the processor, an alternative attraction based on the at least one second attraction wait time. In addition, the method includes identifying, with the processor, an incentive corresponding to the alternative attraction that is determined. Also, the method includes displaying, as a result of the identifying, the incentive on a user interface.

According to another aspect of the present disclosure, the displaying may include transmitting a source page to be displayed on a display, the source page having at least one electronic link, receiving a signal indicating an activation of the at least one electronic link, identifying and retrieving stored data associated with the electronic link in response to a receipt of the signal, and generating and transmitting a second page to be displayed on the display, in which the second page corresponds to the stored data.

According to yet another aspect of the present disclosure, the displaying may include displaying a plurality of incentives.

According to another aspect of the present disclosure, the identifying of the incentive is based on a profile provided by the visitor.

According to yet another aspect of the present disclosure, the attraction condition information includes maintenance information of one or more attractions.

According to a further aspect of the present disclosure, the attraction traffic information is obtained via one or more infrared sensors.

According to a further aspect of the present disclosure, the attraction traffic information is obtained via one or more sensors that detect anonymous device IDs from mobile communication devices.

According to still a further another aspect of the present disclosure, the attraction traffic information is obtained via one video-based sensors.

According to another aspect of the present disclosure, the attraction traffic information is obtained via one or more thermal imaging counters using one or more array sensors that detect heat sources.

According to yet another aspect of the present disclosure, the attraction traffic information is obtained by one or more Wi-Fi receivers that receive Wi-Fi management frames emitted from mobile communication devices.

According to another aspect of the present disclosure, the method may include determining a current location of a visitor.

According to another aspect of the present disclosure, the current location of the visitor is obtained via RFID sensors that receive RFID signals transmitted by a communication device worn by the visitor.

According to another aspect of the present disclosure, the identifying includes determining one of a plurality of potential incentives to offer to the visitor to motivate the visitor to visit the alternative attraction, based upon interests of the visitor provided by the visitor during an online registration process.

According to another aspect of the present disclosure, the method may include accepting a selection of an incentive by the visitor and displaying a route to the alternative attraction.

According to another aspect of the present disclosure, the method may include selecting a second attraction corresponding to the second attraction wait time based on a history of attractions that the visitor has ridden.

According to another aspect of the present disclosure, the calculating the second attraction wait time includes determining wait times of attractions between a current position of the visitor and an intended destination of the visitor.

According to another aspect of the present disclosure, the determining an alternative attraction based on the calculated second attraction wait time includes determining an attraction that is on the current route of the visitor and that has a wait time below a pre-determined threshold.

According to another aspect of the present disclosure, the method may further include polling at least one visitor location source to determine a current location of the visitor, polling traffic sensors to determine current wait times of attractions of interest to the visitor, and polling condition monitors to determine current operating statuses of attractions of interest to the visitor.

According to an aspect of the present disclosure, a tangible non-transitory computer readable storage medium that stores a computer program is provided. The computer program, when executed by a processor, causes a computer apparatus to perform a process. The process includes acquiring visitor attraction interest information, attraction condition information, and attraction traffic information. The process further includes calculating a first visitor route based on the visitor attraction interest information that is acquired. The process also includes calculating a first attraction wait time based on the first visitor route, the attraction condition information and the attraction traffic information. In addition, the process includes calculating a second visitor route if the first attraction wait time that is calculated exceeds a pre-determined threshold. Additionally, the process includes calculating a second attraction wait time based on the acquired visitor attraction interest information and the at least one second visitor route. The process also includes determining an alternative attraction based on the at least one second attraction wait time. In addition, the process includes identifying an incentive corresponding to the alternative attraction that is determined. Also, the process includes displaying, as a result of the identifying, the incentive on a user interface.

According to an aspect of the present disclosure, a computer apparatus is provided including a memory that stores instructions, and a processor that executes the instructions. When executed by the processor, the instructions cause the processor to perform operations. The operations include acquiring, using a processor, visitor attraction interest information, attraction condition information, and attraction traffic information. The operations further include calculating a first visitor route based on the visitor attraction interest information that is acquired. The operations also include calculating a first attraction wait time based on the first visitor route, the attraction condition information and the attraction traffic information. In addition, the operations include calculating a second visitor route if the first attraction wait time that is calculated exceeds a pre-determined threshold. Additionally, the operations includes calculating a second attraction wait time based on the acquired visitor attraction interest information and the at least one second visitor route. The operations also include determining an alternative attraction based on the at least one second attraction wait time. In addition, the operations include identifying an incentive corresponding to the alternative attraction that is determined. Also, the operations include displaying, as a result of the identifying, the incentive on a user interface.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for messaging based on a wait time for an attraction, comprising:
acquiring, using a processor, visitor attraction interest information, attraction condition information, and attraction traffic information;
calculating, with the processor, a first visitor route based on the visitor attraction interest information that is acquired;
calculating, with the processor, a first attraction wait time based on the first visitor route, the attraction condition information and the attraction traffic information;
calculating, with the processor, a second visitor route if the first attraction wait time that is calculated exceeds a pre-determined threshold;
calculating, with the processor, a second attraction wait time based on the acquired visitor attraction interest information and the at least one second visitor route;
determining, with the processor, an alternative attraction based on the at least one second attraction wait time;
identifying, with the processor, an incentive corresponding to the alternative attraction that is determined; and
displaying, as a result of the identifying, the incentive on a user interface.

2. The method of claim 1, wherein the displaying comprises:
transmitting a source page to be displayed on a display, the source page having at least one electronic link;
receiving a signal indicating an activation of the at least one electronic link;
identifying and retrieving stored data associated with the electronic link in response to a receipt of the signal; and
generating and transmitting a second page to be displayed on the display, the second page corresponding to the stored data.

3. The method of claim 1, wherein the displaying comprises:
displaying a plurality of incentives.

4. The method of claim 1, wherein the identifying the incentive is based on a profile provided by the visitor.

5. The method of claim 4, wherein attraction condition information comprises maintenance information of one or more attractions.

6. The method of claim 1, wherein the attraction traffic information is obtained via one or more infrared sensors.

7. The method of claim 1, wherein the attraction traffic information is obtained via one or more sensors that detect anonymous device IDs from mobile communication devices.

8. The method of claim 1, wherein the attraction traffic information is obtained via one video-based sensors.

9. The method of claim 1, wherein the attraction traffic information is obtained via one or more thermal imaging counters using one or more array sensors that detect heat sources.

10. The method of claim 1, wherein the attraction traffic information is obtained by one or more Wi-Fi receivers that receive Wi-Fi management frames emitted from mobile communication devices.

11. The method of claim 1, further comprising:
determining a current location of a visitor.

12. The method of claim 11, wherein the current location of the visitor is obtained via RFID sensors that receive RFID signals transmitted by a communication device worn by the visitor.

13. The method of claim 1, wherein the identifying comprises determining one of a plurality of potential incentives to offer to the visitor to motivate the visitor to visit the alternative attraction, based upon interests of the visitor provided by the visitor during an online registration process.

14. The method of claim 13, further comprising:
accepting a selection of an incentive by the visitor and displaying a route to the alternative attraction.

15. The method of claim 1, further comprising:
selecting a second attraction corresponding to the second attraction wait time based on a history of attractions that the visitor has ridden.

16. The method of claim 1, wherein the calculating the second attraction wait time includes determining wait times of attractions between a current position of the visitor and an intended destination of the visitor.

17. The method of claim 1, wherein the determining an alternative attraction based on the calculated second attraction wait time comprises determining an attraction that is on the current route of the visitor and that has a wait time below a pre-determined threshold.

18. The method of claim 1, further comprising:
polling at least one visitor location source to determine a current location of the visitor;
polling traffic sensors to determine current wait times of attractions of interest to the visitor; and
polling condition monitors to determine current operating statuses of attractions of interest to the visitor.

19. A tangible non-transitory computer readable storage medium that stores a computer program, the computer program, when executed by a processor, causing a computer apparatus to perform a process comprising:
acquiring visitor attraction interest information, attraction condition information, and attraction traffic information;
calculating a first visitor route based on the visitor attraction interest information that is acquired;
calculating a first attraction wait time based on the first visitor route, the attraction condition information and the attraction traffic information;
calculating a second visitor route if the first attraction wait time that is calculated exceeds a pre-determined threshold;
calculating a second attraction wait time based on the acquired visitor attraction interest information and the at least one second visitor route;
determining an alternative attraction based on the at least one second attraction wait time;
identifying an incentive corresponding to the alternative attraction that is determined; and
displaying, as a result of the identifying, the incentive on a user interface.

20. A computer apparatus, comprising:
a memory that stores instructions, and
a processor that executes the instructions,
wherein, when executed by the processor, the instructions cause the processor to perform operations comprising:
acquiring visitor attraction interest information, attraction condition information, and attraction traffic information;
calculating a first visitor route based on the visitor attraction interest information that is acquired;
calculating a first attraction wait time based on the first visitor route, the attraction condition information and the attraction traffic information;
calculating a second visitor route if the first attraction wait time that is calculated exceeds a pre-determined threshold;
calculating a second attraction wait time based on the acquired visitor attraction interest information and the at least one second visitor route;
determining an alternative attraction based on the at least one second attraction wait time;
identifying an incentive corresponding to the alternative attraction that is determined; and
displaying, as a result of the identifying, the incentive on a user interface.
